(19) United States
(12) Patent Application Publication
(10) Pub. No.: US 2024/0333784 A1
(43) Pub. Date: Oct. 3, 2024

(54) MULTI-CDN CONTENT STEERING AT THE EDGE

(71) Applicant: Brightcove Inc., Boston, MA (US)

(72) Inventors: Yuriy A. Reznik, Seattle, WA (US); Bo Zhang, Sharon, MA (US); Guillem Cabrera Anon, Barcelona (ES); Stuart Hicks, London (GB); Biswa Panigrahi, Bothell, WA (US); Meron Ron Zekarias, Seattle, WA (US); Theodore Krofssik, Tucson, AZ (US); Andrew Sinclair, Tasmania (AU)

(73) Assignee: Brightcove Inc., Boston, MA (US)

(21) Appl. No.: 18/621,017

(22) Filed: Mar. 28, 2024

Related U.S. Application Data
(60) Provisional application No. 63/492,735, filed on Mar. 28, 2023.

(51) Int. Cl. H04L 65/80; H04L 65/752

(52) U.S. Cl. CPC H04L 65/80; H04L 65/752

(57) ABSTRACT

A system for steering chunked media content using a plurality of content delivery networks (CDNs) and an edge computing platform, is disclosed. Upon receiving a media content request, a first edge server routes the request to a first CDN for delivering chunks of media content. A second edge server processes a steering request to instantiate a stateless steering server. The second edge server analyzes Quality of Service (QOS) of the CDNs to determine a priority order of the CDNs for future content delivery. The steering server generates a response containing a priority order of CDNs, a time interval for subsequent requests, and a reload URI. The URI triggers a new steering server instantiation with the plurality of CDNs after the time interval. The system enhances media playback by dynamically steering content across CDNs based on QOS analysis.

### PRIORITY

This application is a non-provisional of and claims priority to U.S. Provisional Patent Application No. 63/492,735, filed Mar. 28, 2023, the contents of which are incorporated herein by reference in its entirety:

### BACKGROUND

This disclosure generally relates to content delivering systems and, not by way of limitation, delivering media content by utilizing multiple content delivering networks.

Media content delivery systems serve the purpose of delivering media content from the digital streaming services to end users. Traditional content delivery methods often relied on centralized servers, or at times Content Delivery Networks (CDNs) to cache and deliver media content to the end-users. The CDNs function by performing adjustment to network protocols and content distribution strategies in order to deliver the media content to the end users.

### SUMMARY

In one embodiment, a system for steering chunked media content using a plurality of content delivery networks (CDNs) and an edge computing platform, is disclosed. Upon receiving a media content request, a first edge server routes the request to a first CDN for delivering chunks of media content. A second edge server processes a steering request to instantiate a stateless steering server. The second edge server analyzes Quality of Service (QOS) of the CDNs to determine a priority order of the CDNs for future content delivery: The steering server generates a response containing a priority order of CDNs, a time interval for subsequent requests, and a reload URI. The URI triggers a new steering server instantiation with the plurality of CDNs after the time interval. The system enhances media playback by dynamically steering content across CDNs based on the QOS analysis.

In another embodiment, a system for steering chunked media content using a plurality of content delivery networks (CDNs) and an edge computing platform, is disclosed. The system comprises a first edge server at one of the plurality of CDNs to receive a content request identifying a media content for playback on a client device. The media content is divided into a plurality of chunks. The content request is routed to a first CDN, and deliver at least some of the plurality of chunks from the first CDN. The system further comprises a second edge server at the first CDN to process a steering request to instantiate a first steering server. The first steering server is initially stateless. First parameters from the client device program operation of the first steering server. The second edge server analyzes quality of service (QOS) information for the plurality of CDNs. The second edge server determines a priority order of the plurality of CDNs for delivering the plurality of chunks going forward. The second edge server generates from the first steering server at least two of:
a steering response having a steering route that includes a priority order of the plurality of CDNs;
a time interval for subsequent steering requests; and
a reload uniform resource identifier (URI) to instantiate a second steering server.

The second edge server further passes the reload URI to the client device to trigger a second steering server to be instantiated with the plurality of CDNs after the time interval.

In still embodiment, a method for steering chunked media content using a plurality of content delivery networks (CDNs) and an edge computing platform, is disclosed. The method comprises receiving a content request identifying a media content for playback on a client device. The media content is divided into a plurality of chunks. The content request is routed to a first CDN. The method further comprises delivering at least some of the plurality of chunks from the first CDN. The method further comprises processing a steering request to instantiate a first steering server. The first steering server is initially stateless. First parameters from the client device program operation of the first steering server. The method further comprises analyzing quality of service (QOS) information for the plurality of CDNs. The method further comprises determining a priority order of the plurality of CDNs for delivering the plurality of chunks going forward. The method further comprises generating from the first steering server at least two of:
a steering response having a steering route that includes a priority order of the plurality of CDNs;
a time interval for subsequent steering requests; and
a reload uniform resource identifier (URI) to instantiate a second steering server.

The method further comprises passing the reload URI to the client device to trigger a second steering server to be instantiated with the plurality of CDNs after the time interval.

In yet another embodiment, a non-transitory computer-readable medium having instructions embedded thereon for steering chunked media content using a plurality of content delivery networks (CDNs), is disclosed. The instructions, when executed by one or more computers, cause the one or more computers to receive a content request identifying a media content for playback on a client device. The media content is divided into a plurality of chunks. The content request is routed to a first CDN. The instructions, when executed by one or more computers, further cause the one or more computers to deliver at least some of the plurality of chunks from the first CDN The instructions, when executed by one or more computers, further cause the one or more computers to process a steering request to instantiate a first steering server. The first steering server is initially stateless. First parameters from the client device program operation of the first steering server. The instructions, when executed by one or more computers, further cause the one or more computers to analyze quality of service (QOS) information for the plurality of CDNs. The instructions, when executed by one or more computers, further cause the one or more computers to determine a priority order of the plurality of CDNs for delivering the plurality of chunks going forward. The instructions, when executed by one or more computers, further cause the one or more computers to generate from the first steering server at least two of:
a steering response having a steering route that includes a priority order of the plurality of CDNs;
a time interval for subsequent steering requests; and
a reload uniform resource identifier (URI) to instantiate a second steering server.

The instructions, when executed by one or more computers, further cause the one or more computers to pass the reload URI to the client device to trigger a second steering server to be instantiated with the plurality of CDNs after the time interval.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 illustrates a schematic representation of a delivery environment for media content, according to an embodiment of the present disclosure;

FIG. 2 illustrates a block diagram of a system for steering chunked media content using a plurality of content delivery networks (CDNs) and an edge computing platform, according to an embodiment of the present disclosure:

FIG. 3 illustrates a block diagram of a system for steering chunked media content using the plurality of CDNs and the edge computing platform, according to another embodiment of the present disclosure:

FIG. 4 illustrates a swim lane diagram of a content steering process executed by various elements of the media content steering system according to an embodiment of the present disclosure:

FIG. 5 illustrates a media presentation description (MPD) file according to an embodiment of the present disclosure:

FIG. 6 illustrates a media presentation description (MPD) file according to an embodiment of the present disclosure:

FIG. 7 illustrates a method for steering media content according to an embodiment of the present disclosure; and

FIG. 8 illustrates a method for steering media content according to another embodiment of the present disclosure.

In the appended figures, similar components and/or features may have the same reference label. Further, various components of the same type may be distinguished by following the reference label by a second alphabetical label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only; and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

Embodiments described herein are generally related to systems and methods for steering chunked media content using a plurality of content delivery networks (CDNs). In particular, some embodiments of the disclosure describe leveraging the CDN infrastructure of the content edge server to dynamically instantiate a steering server. The steering server, upon analysis of Quality of Service (QOS) information for the available CDNs, generates a Uniform Resource Identifier (URI) to trigger the instantiation of the next steering server, optimizing the content delivery process across multiple CDNs.

By utilizing the CDN infrastructure of the content edge server to instantiate and manage the steering server, the system enables efficient content delivery across the CDNs. This approach allows for dynamic adaptation to changing network conditions and load distribution, ensuring optimal media playback experience for end users.

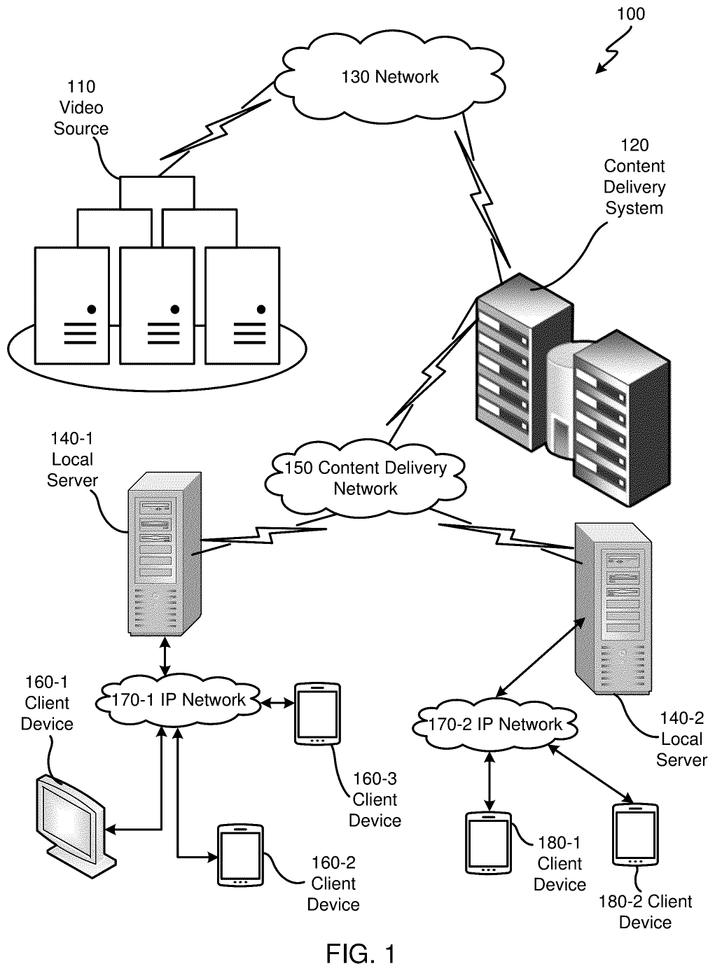

Referring to FIG. 1 illustrates a media content delivery environment 100 having various components and entities engineered to efficiently distribute diverse media content to end-users worldwide. The environment 100 comprises a video source 110, which refers to an origin server or database that houses the original media content, including videos, audio, and other multimedia files. The video source serves as a primary repository from which content is sourced for distribution to the end-users.

In the context of the media content delivery environment 100, the video source 110 acts as the central hub where content creators upload, store, and manage their media assets. It provides a secure and reliable storage solution for hosting a vast library of video content, enabling seamless access and retrieval when requested by the end-users. The video source 110 may include robust database management systems and storage infrastructure to efficiently handle large volumes of media files and metadata associated with each piece of content.

The environment 100 comprises further comprises a content delivery system 120 that is connected to the video source 110 via a network 130. In some embodiments, the content delivery system 120 employs advanced algorithms and protocols to optimize content delivery, ensuring optimal performance and quality of service (QOS) and quality of experience (QoE). Leveraging real-time analytics and machine learning algorithms, the system dynamically adjusts content delivery strategies based on factors such as user preferences, the network conditions, and device capabilities.

To facilitate efficient communication between the content delivery system 120 and the video source 110, the network 130 is provided with a high-speed network infrastructure. The high-speed network infrastructure enables rapid retrieval of media files from the video source 110, minimizing latency and ensuring timely delivery to the end-users.

Additionally, the network 130 employs robust security protocols to safeguard against unauthorized access and data breaches, ensuring the integrity and confidentiality of transmitted content.

In addition, the content delivery system 120 is interconnected with local servers 140-1, 140-2 via a content delivery network 150. The “content delivery network” (CDN) 150 refers to a distributed network infrastructure designed to deliver various types of digital content, including media files, web pages, and streaming media, to the end-users. The distributed network infrastructure typically consists of a network of geographically distributed servers, for example the local servers 140-1, 140-2 strategically positioned at multiple points of presence (PoPs) around the world. The local servers 140-1, 140-2, may also be known as edge servers or caching servers, work collaboratively to optimize the delivery of content to the end-users while minimizing latency and reducing network congestion. The local servers 140-1, 140-2 serve as edge nodes strategically deployed closer to the end-users to enhance delivery efficiency. Through a process known as edge caching, these servers store frequently accessed content locally; reducing latency and bandwidth usage. By leveraging edge caching, the system can deliver content more quickly and reliably, even during periods of high demand or network congestion.

The local servers 140 further communicate with the client devices 160 via IP networks. Specifically; the local server 140-1 is connected to the client devices 160-1, 160-2, and 160-3 via a first IP network 170-1, while local server 140-2 is connected to the client devices 180-1 and 180-2 via a second IP network 170-2. The delivery of media content from the servers to the end-user devices are performed over IP-based communication channels.

IP networks, or Internet Protocol networks facilitate the transmission of data packets between multiple devices connected to the internet. These networks rely on the Internet Protocol (IP) suite for addressing and routing data packets across interconnected networks. IP networks can be implemented using various technologies, including Ethernet, Wi-Fi, and cellular networks, depending on the specific requirements of the deployment environment.

Within the IP networks, various communication protocols are employed to deliver media content to client devices. One such protocol is Dynamic Adaptive Streaming over HTTP (DASH), which enables the adaptive streaming of multimedia content over standard HTTP connections. DASH segments the media content into smaller chunks and dynamically adjusts the bitrate and resolution based on the available network bandwidth and client device capabilities, ensuring smooth playback and optimal viewing experience.

Another widely used protocol is HTTP Live Streaming (HLS), which segments media content into smaller files and serves them over standard HTTP connections. HLS supports adaptive bitrate streaming, allowing client devices to switch between different quality levels based on the network conditions. This protocol is commonly used for streaming live events, online video platforms, and video-on-demand services.

In addition to DASH and HLS, other protocols such as Real-Time Messaging Protocol (RTMP), Smooth Streaming, and MPEG Transport Stream (MPEG-TS) may also be employed within IP networks for specific use cases and requirements. These protocols offer different features and capabilities for delivering media content efficiently and reliably to client devices over IP-based communication channels.

Overall, the adoption of IP networks and various communication protocols like DASH, HLS, RTMP, and others ensures the seamless delivery of media content from local servers to client devices, enabling the end-users to access and enjoy multimedia content over the internet with high quality and reliability:

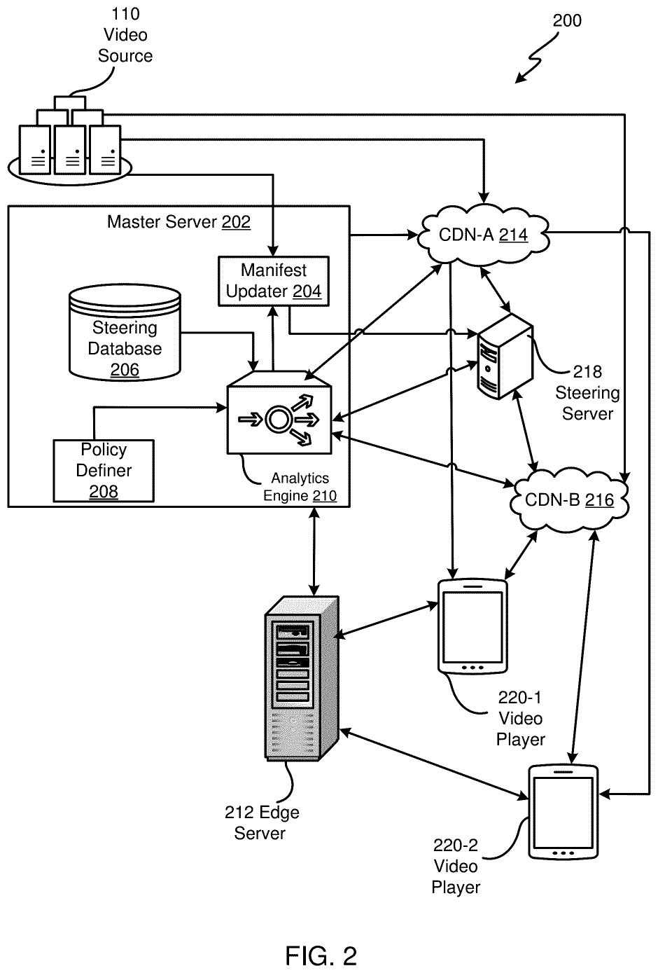

Referring to FIG. 2, illustrates a block diagram of a system 200 for steering chunked media content using content delivery networks (CDNs) 214, 216, according to an embodiment of the present disclosure.

The system 200 comprises a master server 202 equipped with various components including a manifest updater 204, a steering database 206, a policy definer 208, and an analytics engine 210. The master server 202 serves as the central hub for managing and analyzing playback statistics associated with media content delivery.

The steering database 206 and the policy definer 208 collectively serve as critical components for managing and orchestrating content delivery operations. These components work in tandem to store, analyze, and enforce policies governing the selection and optimization of CDN resources, ensuring efficient and reliable content delivery to the end-users.

The steering database 206 functions as a centralized repository for storing metadata, configuration settings, and historical performance data related to the CDNs 214, 216 and the streaming media content. The steering database 206 maintains comprehensive records of CDN performance metrics, including throughput, latency; availability; and reliability; allowing the system 200 to make informed decisions regarding CDN selection, load balancing, and content routing.

Additionally, the steering database 206 stores user-specific preferences, session parameters, and content delivery policies, enabling the system to tailor content delivery strategies based on individual user requirements, the network conditions, and quality of service objectives. By leveraging the insights derived from the steering database 206, the system 200 can dynamically adjust content delivery routes, prioritize the CDN resources, and optimize streaming performance to meet user expectations and ensure a seamless playback experience.

The policy definer 208 complements the functionality of the steering database 206 by providing a configurable framework for defining and enforcing content delivery policies and rules. This component allows administrators to establish rulesets, thresholds, and decision criteria governing CDN selection, load balancing strategies, and content routing algorithms. The policy definer 208 supports a range of policy definitions, including geographic-based routing, performance-based routing, cost optimization policies, and quality of service thresholds, enabling administrators to customize content delivery strategies to align with business objectives and user preferences.

Furthermore, the policy definer 208 integrates with the analytics engine and the manifest updater 204 to continuously monitor CDN performance, user engagement metrics, and the network conditions, enabling real-time policy adjustments and optimization. By dynamically adapting content delivery policies based on evolving conditions and requirements, the policy definer 208 ensures efficient resource utilization, optimal content delivery performance, and enhanced quality of experience for the end-users.

The analytics engine 210 serves as a pivotal component within the system 200 for collecting, processing, and analyzing vast amounts of data related to CDN performance, user engagement metrics, the network conditions, and content consumption patterns.

Leveraging advanced analytics algorithms, the analytics engine 210 aggregates data from various sources, including CDN logs, video player telemetry; user interactions, and network monitoring tools. By processing this data in real-time, the analytics engine 210 generates actionable insights and the CDN performance metrics, enabling stakeholders to gain deeper visibility into the efficiency; reliability; and scalability of the content delivery ecosystem.

One of the key functions of the analytics engine 210 is to monitor and evaluate the CDN performance metrics, such as throughput, latency; error rates, and cache hit ratios, across different geographic regions and network segments. By continuously assessing CDN performance and availability; the analytics engine 210 identifies potential bottlenecks, latency issues, or reliability concerns, allowing administrators to proactively address them and optimize content delivery routes in real-time.

Additionally, the analytics engine 210 provides valuable insights into user behavior, content consumption patterns, and quality of experience metrics, such as buffering events, playback interruptions, and video quality fluctuations. By analyzing user engagement data and quality metrics, the analytics engine 210 helps identify areas for improvement in content delivery performance, content caching strategies, and streaming protocols, ultimately enhancing the overall quality of service and user satisfaction.

The system 200 further comprises an edge server 212 that is connected to the master server 202 and plays a critical role in real-time content delivery decision-making.

Additionally, the system 200 comprises multiple CDNs represented by CDN-A 214 and CDN-B 216, which are responsible for distributing media content to the end-users. It is noted that, for clarity of illustration, only two CDNs (CDN-A 214 and CDN-B 216) are depicted. However, it is to be understood that the number of CDNs may vary based on multiple factors, such as network topology; geographical distribution of the end-users, and service level agreements with CDN providers.

The edge server 212 plays a pivotal role in optimizing content delivery by serving as a strategic intermediary between the master server 202 and the CDNs (CDN-A 214 and CDN-B 216). The edge server 212, positioned at the edge of the network infrastructure, is strategically deployed to minimize latency and enhance the responsiveness of content delivery operations.

The edge server 212 is interconnected with the master server 202 via a high-speed network connection, ensuring seamless communication and data exchange between the central control unit and the distributed edge infrastructure. This connection enables the edge server 212 to receive real-time instructions, updates, and directives from the master server 202, allowing it to dynamically adjust content delivery strategies based on the changing network conditions and user demands.

Furthermore, the edge server 212 is equipped with advanced caching and routing capabilities, allowing it to intelligently route content requests, cache frequently accessed media assets, and dynamically adjust content delivery pathways based on factors such as network congestion, server load, and user proximity. By serving as a strategic caching and routing node at the network edge, the edge server 212 enhances content delivery efficiency, reduces latency; and improves overall quality of experience for the end-users accessing streaming media content.

The video source 110 is intricately connected to the master server 202 and the CDNs (CDN-A 214 and CDN-B 216) to facilitate content delivery: The connection between the video source 110 and the master server 202 enables transfer of media content and associated metadata required for content management and delivery.

By establishing a connection with the master server 202, the video source 110 ensures that relevant content requests and updates are promptly communicated to the central control unit responsible for steering content delivery across the CDNs.

Additionally, the video source 110 maintains direct connections with each CDN (CDN-A 214 and CDN-B 216) to facilitate distribution of media content to the end-users. These connections are vital for initiating content delivery requests, transferring media assets, and synchronizing content updates across the distributed network infrastructure.

The connections between the video source 110 and the master server 202, as well as the CDNs (CDN-A 214 and CDN-B 216), form the backbone of the system 200, enabling seamless coordination and synchronization of media content delivery operations. By establishing robust communication channels, the system 200 optimizes resource utilization, minimizes latency, and enhances overall performance, thereby ensuring a superior quality of experience (QoE) for the end-users accessing streaming media content.

The system further comprises a steering server 218 that is responsible for orchestrating CDN selection and content delivery decisions. The steering server 218 receives updated manifest files from the manifest updater 204 to dynamically switch between CDN-A 214 and CDN-B 216 based on load balancing decisions determined by the analytics engine 210.

In operation, the master server 202 initially performs analytics related to the playback statistics, leveraging data from CDN logs, video player logs, and other sources. Subsequently, the edge server 212 takes charge of all subsequent CDN steering decisions for each streaming session in real time.

Video players 220-1, 220-2 are typically deployed on client devices 160, 180 and are responsible for rendering multimedia streams received from the CDNs. In the depicted system 200, video players 220-1 and 220-2 receive media content from either of CDN-A or CDN-B based on load balancing decisions made by the analytics engine 210.

The updated manifest file, generated by the manifest updater 204 and incorporating real-time steering decisions from the steering server 218, plays a vital role in guiding the behavior of video players 220-1 and 220-2. This manifest file contains metadata and instructions necessary for the video players to retrieve and play back media content efficiently. It includes information such as the URLs of available content chunks, bitrate options, segment durations, and CDN selection directives. In some embodiments, the manifest updater 204 updates the manifest file received in the content request with URI's of at least some of the plurality of chunks, and upon updating, transmits the manifest file to the client device in accordance with Dynamic Adaptive Streaming over HTTP (DASH) or HTTP Live Streaming (HLS) protocols.

To receive media content, video players 220-1 and 220-2 establish connections with the edge server 212, which acts as a gateway between the client devices and the content delivery infrastructure. These connections are typically established using standard communication protocols. Once connected, the video players 220-1 and 220-2 send requests to the edge server 212 for the required content segments, based on the instructions provided in the manifest file, the edge server 212 orchestrates the retrieval of content segments from the designated CDN (either CDN-A or CDN-B) based on the load balancing decisions determined by the analytics engine 210.

The edge server 212 then streams the requested content segments to the respective video players, ensuring seamless playback and optimal user experience. This dynamic content delivery mechanism allows for efficient utilization of available CDN resources and adaptive delivery of media content based on the changing network conditions and the user demand.

Below is load balancing optimization solution optimization problem that may be solved by a server:

### Given:

K CDNs
N regions
C_{CDN,region}(T)—per GB delivery cost of each CDN in each Region
C_{CDN}^{committed}—minimum committed $ amount per each CDN
T_{CDN}^{committed}—minimum committed traffic amount [in PB] per each CDN
T_{region}—anticipated traffic in each region

### Find:

factors [α_{CDN,region}], 0≤α_{i,j}≤1, such that Σᵢ₌₁^{K}α_{i,region}=1, defining fractions of traffic that will be routed to each CDN in each region,
   Such that:
total delivery cost:

$${C}_{total} ( α ) = {\sum }_{i = 1}^{K} {\sum }_{j = 1}^{N} {C}_{i , j} ( {T}_{j} * {α}_{i , j} )$$

is minimal, subject to commitment constraints for each CDN:

$$∀ i := {\sum }_{j = 1}^{N} {C}_{i , j} ( {T}_{j} * {α}_{i , j} ) \geq {C}_{i}^{committed}$$

$$and / or$$

$$∀ i := {\sum }_{j = 1}^{N} {T}_{j} * {α}_{i , j} \geq {T}_{i}^{committed}$$

In other words, we need to find vectors [symbol] such that:

$${C}_{total} ( ) = {min}_{α , subject} aboveconstraintsC {total}_{} ( α )$$

This is a classic non-linear constrained optimization problem.

The main source of complication here is that CDN cost functions C_{CDN,region} (T) are generally non-monotonic and non-differentiable. One way of solving it is to map everything in discrete domain-effectively quantize factors alpha to some precision (e.g. over A_n lattice) and then solve the problem by combinatorial search.

This problem is one of the example optimizations problems that may be solved by the steering server. More generally, optimization objectives and functions of steering servers may include achieving better QOE, better balance between QOE and costs, failover protection, achieving better scalability/reach, etc.

Furthermore, the factors for load-balancing are translated to CDN priority orders by using a classic random number generator to pick the CDN to be placed on the top of the list, and the rest are included in order of decrease of their desired load probabilities. It can be easily implemented in a serverless fashion.

When load distribution between different CDNs is determined, the following functions may be used to generate a priority list of CDNs.

```
/*
  * CDN selection function: select_preferred_cdn( )
  *
  * This function generates index of the top CDN that should be used
  * to achieve a particular load distribution.
  *
  * Input parameters:
```

| | |
|---|---|
| * n | - number of CDNs |
| * p[ ] | - target CDN load distribution |

```
  *
  *
  * Returns:
  * >=0 - index of the CDN to use
  * −1 - error
  */
int select_preferred_cdn(int n, double p[ ])
{
  int i, k; double r;
  /* check input parameters: */
  if (n<0 || n>=MAX_CDNS || p == NULL || session_ping < 0) return −1;
  for (r=0,i=0;i<n;i++,r+=p[i]) if(p[i]<0 || p[i]>1) return −1;
  if (fabs(r−1) < 1e−5) return −1;
  /* generate random number according to distribution p[ ]: */
```

| | |
|---|---|
| r = (double)rand( )/RAND_MAX; | // random value in [0,1) |
| for (k=0; k<n && (r −= p[k]) >= 0; k++) ; | // find k, s.t. \sum_{i<k} p[i] <= r < \sum_{i <= k} p[i] |

```
  /* return index of the CDN selected */
  return k;
}
/*
  * Generate a list of CDNs to return to the client.
  *
  * This function maybe called as sequel to select_preferred_cdn( ) to generate
  * the list of CDNs in order from most preferred to least preferred.
  * The CDN in top position is already selected by select_preferred_cdn( ).
  * This is sufficient for load balancing. The rest of CDNs are mostly needed
  * for failover proterction.
  * The code below places them in order of decreased load allocation.
  * Thus, the CDNs with 0 load will be listed last by this algorithm.
  */
int generate_ordered_list_of_cdns(int n, double p[ ], int preferred, int cdn_list[ ])
{
  int i, j, t;
  /* check input parameters: */
  if (n<0 || n>=MAX_CDNS || p == NULL || preferred < 0 || preferred >= n || cdn_list == NULL)
  return −1;
  /* form the initial list, placing the preferred CDN on the top: */
  cdn_list[0] = preferred;
  for (i=0; i<preferred; i++) cdn_list[1+i] = i;
  for (i++; i<n; i++) cdn_list[i] = i;
  /* bubble-sort cdn_list[1..n] in order of decreasing probabilities: */
  for (i=1; i<n−1; i++) {
  for (j=1; j<n−i−1; j++) {
    if (p[cdn_list[j]] < p[cdn_list[j+1]]) {
    /* swap j & j+1 entries: * /
    t = cdn_list[j];
    cdn_list[j] = cdn_list[j+1];
    cdn_list[j+1] = t;
    }
  }
  }
  /* success: */
  return 0;
}
```

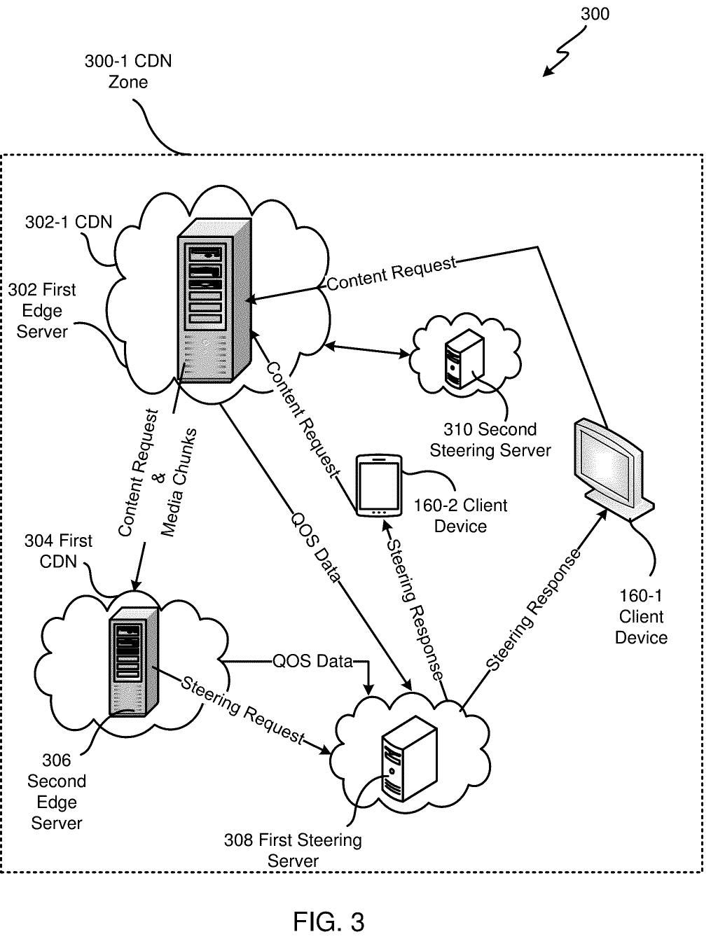

Referring to FIG. 3, illustrates a block diagram of a system 300 for steering chunked media content in a zone 300-1 having multiple content delivery networks, according to another embodiment of the present disclosure. The system 300 comprises a first edge server 302, strategically positioned within one CDN 302-1 of the multiple CDNs to handle incoming content requests from client devices 160. In some embodiments, the first edge server 302 is situated at an edge computing platform. Here, the term “edge computing platform” refers to a distributed computing infrastructure that brings computational resources closer to the data source or end-users. Unlike traditional cloud computing, where data processing occurs in centralized data centers, edge computing decentralizes computation by placing servers and processing resources closer to the point of data generation or consumption.

For example, when a user accesses a streaming media service on a mobile device. In this case, the first edge server 302, situated within the edge computing platform, can dynamically analyze the user's content request, optimize content delivery pathways based on real-time network conditions, and deliver streaming media content with minimal latency. By processing content steering requests and CDN prioritization decisions at the edge, the edge computing platform enhances the overall quality of experience (QoE) for end-users while efficiently managing network resources. The content requests enable the identification of specific media content intended for playback. The media content is segmented into multiple chunks to facilitate efficient delivery over the CDNs. Upon receiving a content request, the first edge server 302 routes the request to the first CDN 304 and delivers relevant content chunks to initiate the playback process.

To enhance the efficiency and reliability of content delivery, the system 300 incorporates a second edge server 306, situated within the first CDN 304. The second edge server 306 is responsible for processing steering requests and instantiating a first steering server 308, which operates initially in a stateless manner. The operation of the first steering server 308 is programmed based on first parameters received from the client device 160, enabling personalized and adaptive content steering.

In an exemplary scenario, when a user accesses a video streaming platform on a mobile device to watch a popular live sports event and initiates playback, a content request is transmitted from the mobile device to the first edge server 302 within the content delivery network (CDN). The content request specifies the desired media content, which is divided into multiple chunks for efficient transmission. In some embodiments, the content request received at the first edge server comprises a manifest file that includes metadata associated with the media content.

In some embodiments, the content request may be similar to a content steering request received the first edge server 302 of the edge computing platform a media player or the video player 220. The content steering request includes an indication of a current CDN used by the media player to receive chunked media content. Further the content steering request includes an indication of a throughput of a current CDN, as measured by the client device 160 for receiving chunked media content. Further the content steering request includes a parameter string carrying information about the state of the steering server, including the priority order of the CDNs used for delivery quality of service (QOS) information for the plurality of CDNs in the priority order list.

In some embodiments, the first edge server 302 of the edge steering platform is configured to generate a new state of the steering server, including an updated priority order for list of the CDNs, and updated QOS information for the plurality of CDNs in the priority order list. The term “new state” refers to an adjusted priority order for the list of CDNs and refreshed quality of service (QoS) information corresponding to the plurality of CDNs in the priority order.

For example, when a user initiates a content playback request on a streaming platform using the client device 160. Upon receiving the content request, the first edge server 302 processes the steering request and assesses the current network conditions and CDN performance metrics. Based on this analysis, the first edge server 3002 generates the new state for the steering server, incorporating an updated priority order for the available CDNs and the latest QoS information.

In a scenario, where an initial CDN priority order assigned for content delivery is CDN-A, CDN-B, and CDN-C and during the streaming session, the first edge server 302 detects deteriorating performance metrics for CDN-B due to network congestion or server issues. In response, first edge server 302 dynamically adjusts the priority order, promoting CDN-C to a higher priority position and demoting CDN-B. The updated priority order now becomes CDN-A, CDN-C, and CDN-B, reflecting the revised CDN prioritization based on real-time network conditions.

Furthermore, the first edge server 302 updates the QoS information associated with each CDN in the priority order list. This includes metrics such as throughput, latency, and packet loss rates, which are crucial for determining the optimal CDN selection for content delivery. By continually refreshing the QoS information and adjusting the priority order accordingly, the edge steering platform ensures efficient and reliable content delivery, enhancing the overall quality of experience for end-users.

In some embodiments, the first edge server 302 generates a steering response for the media player, including an updated priority order of the plurality of the CDNs, a time interval for subsequent steering requests and a reload uniform resource identifier (URI) to instantiate a second edge server 306 of the edge computing platform. The reload URI includes parameter string carrying information about the new state of the steering server generated while processing the current request.

For example, when a user initiates a content playback request via the media player. Upon receiving the request, the first edge server 302 undertakes a series of operations to optimize content delivery. After analyzing factors such as network conditions, CDN performance metrics, and user preferences, the edge server dynamically updates the priority order of available CDNs to ensure optimal content delivery. Subsequently, the first edge server 302 determines a suitable time interval for future steering requests, considering factors like anticipated network stability and CDN load balancing requirements.

Moreover, as part of the steering response, the first edge server 302 generates a reload URI containing a parameter string. This parameter string encapsulates crucial details regarding the revised state of the steering server, including the updated CDN priority order and relevant QoS metrics. By including this information in the reload URI, the media player can effectively instantiate a secondary edge server within the edge computing platform, thereby facilitating seamless and efficient content steering for subsequent playback sessions.

In some embodiments, the edge computing platform may also be seamlessly integrated within the infrastructure of the same content delivery networks (CDNs) responsible for content distribution.

Upon receiving the content request, the first edge server 302 routes the request to the first CDN 304, which houses the second edge server 306. The second edge server 306, equipped with advanced processing capabilities, evaluates the incoming request and determines the optimal content delivery pathway based on real-time network conditions and quality of service (QOS) metrics. In some embodiments, first edge server is configured to periodically monitors the performance metrics of the plurality of CDNs to analyze load distribution across the plurality of CDNs, and adjust the priority order of the plurality of CDNs for delivering the plurality of chunks based on the load distribution.

Subsequently, the second edge server 306 instantiates a first steering server 308 to manage the content delivery process. Notably, the first steering server 308 operates in a stateless manner initially. In other words, the first steering server does not retain any session-specific data between requests. Instead, the operation of the first steering server 308 is dynamically programmed based on first parameters received from the client device 160. In some embodiments, the first steering sever is configured to monitor a throughput of a live CDN from the plurality of CDNs.

These first parameters may include information such as device type, network bandwidth, geographical location, and user preferences. By analyzing the first parameters, the first steering server 308 can adaptively adjust the content delivery strategy to ensure optimal performance and user experience. In some embodiments, the first parameters from the client device includes bandwidth, latency, and throughput information. For instance, if the client device 160 experiences fluctuations in network bandwidth, the first steering server 308 may prioritize content delivery via a CDN with higher bandwidth capacity to mitigate buffering issues and maintain seamless playback. In some embodiments, the first steering server is configured to dynamically adjust the steering route based on real-time changes in network conditions, performance metrics of the plurality of CDNs, and indicators associated with quality of experience (QOE) and quality of service (QOS).

Additionally, the second edge server 306 analyzes quality of service (QOS) information across the plurality of CDNs to determine a priority order for delivering content chunks in subsequent sessions. In some embodiments, the second edge server analyzes the QOS information by monitoring performance metrics of each of the plurality of CDNs in real-time, and analyzing data associated with historical performance of each of the plurality of CDNs in real-time. Leveraging this analysis, the second edge server 306 generates a steering response comprising a steering route specifying the priority order of CDNs, a time interval for subsequent steering requests, and a reload uniform resource identifier (URI) to instantiate a second steering server 310. The reload URI is communicated to the client device 160 to trigger the instantiation of the second steering server 310, ensuring dynamic and responsive content steering over time.

In some embodiments, the second edge server 308 determines the priority order for each of the plurality of CDNs comprises considering data associated with historical performance of each of the plurality of CDNs, geographical proximity of the plurality of CDNs to the client device, and network conditions at the client device. In some embodiments, the first and the second edge servers use a same server at the first CDN. This shared infrastructure allows for seamless communication and coordination between the two edge servers, enabling them to collaborate in real-time to analyze network conditions, process steering requests, and dynamically adjust CDN priorities for content delivery.

For instance, when a user initiates a video playback session, the first edge server receives the initial content request and routes it to the first CDN for delivery. Meanwhile, the second edge server, also hosted on the same CDN infrastructure, monitors the network and CDN performance, assisting in analyzing quality of service (QoS) information and determining optimal CDN priorities.

By leveraging the same server infrastructure, the first and second edge servers can efficiently exchange information and collaborate in steering content delivery across multiple CDNs. In an example scenario, when a user accesses a video streaming platform to watch a high-definition movie on his smart TV and begins streaming the movie, the second edge server 306 within the content delivery network (CDN) analyzes quality of service (QOS) information gathered from previous streaming sessions across multiple CDNs.

Based on this analysis, the second edge server 306 determines a priority order for delivering content chunks in subsequent sessions. For instance, if one CDN consistently demonstrates higher throughput and lower latency compared to others, it may be assigned a higher priority in the delivery sequence.

Subsequently, the second edge server 306 generates a steering response tailored to the specific requirements of the user's streaming session. The steering response includes a steering route outlining the priority order of CDNs for delivering content chunks, ensuring that chunks are retrieved from the most suitable CDN based on current network conditions and performance metrics.

Additionally, the steering response specifies a time interval for subsequent steering requests, allowing for periodic re-evaluation and adjustment of the CDN priority order as network conditions evolve overtime. To facilitate seamless transition between steering sessions, the second edge server 306 generates a reload uniform resource identifier (URI), which is communicated to the client device 160.

Upon receiving the reload URI, the client device 160 triggers the instantiation of the second steering server 310, enabling dynamic and responsive content steering for future streaming sessions. By continuously adapting to changing network dynamics and user preferences, the system 300 ensures optimized content delivery and enhanced quality of experience (QOE) for media consumers across diverse streaming environments.

In an example embodiment, implementation of steering operations by means of stateless “compute functions” such as AWS Lambdas or Lambdas @ Edge. Further implementable by using Fastly's VCL platform. With Fastly, one can create entirely synthetic response bodies. These have to be created entirely in the VCL, and they cannot modify a response from the origin. Alternatively, with one can modify response bodies that came from an origin using ESI (Edge Side Includes).

In the extreme forms of edge computing environments—such as CloudFront Functions of Akamai Edge Workers we do not have luxury of modifying the body of HTTP requests. At most, such systems can only modify the parameters of HTTP headers, and URL string sent with the HTTP request.

TABLE 1
Examples of steering server response variants for a system with 2 CDNs.

| response variant 1: | response variant 2: |
|---|---|
| { | { |
| “VERSION”: 1, | “VERSION”: 1, |
| “TTL”: 30, | “TTL”: 30, |
| “RELOAD-URI”: “https://steeringserver.com” | “RELOAD-URI”: “https://steeringserver.com” |
| “SERVICE-LOCATION-PRIORITY”: [“alpha”, “beta”] | “SERVICE-LOCATION-PRIORITY”: [“beta”, “alpha”] |
| } | } |

If the system 300 uses 3 CDNs (called alpha, beta, gamma), then we effectively will need 3!=6 files, corresponding to all possible orders of these 3 CDNS.

TABLE 2
Examples of response variants for a system with 3 CDNs (only pathway orders are shown).

| response variant 1: | response variant 2: | response variant 3: |
|---|---|---|
| { | { | { |
| ... | ... | ... |
| “SERVICE-LOCATION-PRIORITY”: | “SERVICE-LOCATION-PRIORITY”: | “SERVICE-LOCATION-PRIORITY”: |
| [“alpha”, “beta”, “gamma”] | [“alpha”, “gamma”, “beta”] | [“beta”, “alpha”, “gamma”] |
| } | } | } |
| response variant 4: | response variant 5: | response variant 6: |
| { | { | { |
| ... | ... | ... |
| “SERVICE-LOCATION-PRIORITY”: | “SERVICE-LOCATION-PRIORITY”: | “SERVICE-LOCATION-PRIORITY”: |
| [“beta”, “gamma”, “alpha”] | [“gamma”, “alpha”, “beta”] | [“gamma”, “beta”, “alpha”] |
| } | } | } |

Indeed, by considering the need to also communicate the server's state, the number of responses will be larger, but with some careful thinking it may also be reduced to a rather small number of unique states to be stored in the response files.

For example, if we want to remember last active CDN throughput/bandwidth—it probably can be quantized to just 5-6 states using logarithmic scale, and that would be adequate for decision making. In extreme end, it may also be quantized to just 2 states or 3 states as shown in table below.

TABLE 3
Example of quantization of CDN bandwidth/throughput
parameter to 3 states.

| | | Significance for steering |
|---|---|---|
| State | Condition | server |
| 1 | Bandwidth < lowest bandwidth of | Client is buffering or about |
| | variant stream in manifest | to start buffering |
| 2 | lowest bandwidth < Bandwidth < | Client is playing but not |
| | highest bandwidth of variant | delivering best experience |
| | stream in manifest | |
| 3 | Bandwidth > highest bandwidth | Bandwidth is adequate for |
| | of variant stream in manifest | high-quality streaming of a |
| | | given content |

Overall, by assuming that we need to deal with k CDNs, and that server's internal state can be reduced to N variants, we see that the total number of unique responses that we will need to create and store as separate files becomes N*k! E.g., if k=3 and N is 12, it becomes 12*6=72 files. Quite manageable.

In passing, we also note that in cases when the server state needs to remember the last priority order of CDNs sent to the client—this does not increase the number of response variants required! Each variant is already unique to such CDN order, so embedding it in the state/reload URI parameter sting is possible without adding any extra files. This can easily save a factor of 2 or 6 (3 CDNs) or 24 (4 CDNs) in the number of response files used by the system.

In some embodiments, the steering server may perform pathway cloning of HLS and DASH. This feature helps to scale the streaming infrastructure dynamically by adding new CDN's to existing list. This is implemented by adding “PATHWAY-CLONES” tag to steering server response. Which lets existing/running players to know about addition of cloned CDN. A Pathway Clone is produced by taking an existing Pathway and applying well-defined replacements to the Rendition URIs of every Pathway member.

A Pathway Clone object is a JSON object as shown below.

B.1. Basic Pathway Cloning Manifest response: This is the basic pathway cloning method, supported by both HLS and DASH:

```
{
  “VERSION”: 1,
  “TTL”: 60,
  “RELOAD-URI”: “http://
steeringserver.com?steering_params=eyJwcmV2UHRzIjpbImNkbl9hIiwiY2RuX2IiXSwicHRzIjpbeyJpZCI6ImNkbl9hIiwidGhy
b3VnaHB1dCI6IjIwOTcxNTIwMCJ9LHsiaWQiOiJjZG5fYiIsInRocm91Z2hwdXQiOiIyMDk3MTUyMDAifV0sIm1pbkJSIjoiN
TM2MjQ3OSJ9”,
  “PATHWAY-PRIORITY”: [
  “cdn1”,
  “cdn2”,
  “cdn3”
  ],
  “PATHWAY-CLONES”: [
  {
    “BASE-ID”:“cdn1”, // REQUIRED. Pathway ID of the Base Pathway from which cloning is done
    “ID”: “cdn3”, // REQUIRED. Pathway ID for the Pathway Clone
    “URI-REPLACEMENT”: // REQUIRED. URI replacement rules
    {
    “HOST”: “http://cdn3.com/<Base_URL>”, // OPTIONAL. Hostname for cloned URIs
    “PARAMS”: // OPTIONAL. Query parameters for cloned URIs
    {
      “steering_params”: < New Params>
    }
    }
  }
  ]
}
```

Here the playlist with URL which is replaced with cloned host URL as shown below. This URI replacement applies to all the variants in the master playlist. B3.2. Pathway Cloning with Variant and Rendition Replacement response.

This is a variant of this feature currently only supported by HLS.

If the STABLE-VARIANT-ID of aVariant Stream on the new Pathway appears in PER-VARIANT-URIS, set its URI to be the corresponding value in PER-VARIANT-URIS.

If the STABLE-RENDITION-ID of a Rendition referred to by a Variant Stream on the new Pathway appears in PER-RENDITION-URIS, set its URI to be the corresponding value in PER-RENDITION-URIS.

Here is the HLS Multi-Variant Playlist with Steering Manifest using tag STABLE-VARIANT-ID and STABLE-RENDITION-ID:

```
#EXTM3U
#EXT-X-CONTENT-STEERING:SERVER-URI=“/steering?video=00012”, \
  PATHWAY-ID=“CDN-A”
#EXT-X-MEDIA:TYPE=AUDIO,GROUP-ID=“A”,NAME=“English”,DEFAULT=YES, \
  URI=“eng.m3u8”,LANGUAGE=“en”,STABLE-RENDITION-ID=“Audio-37262”
#EXT-X-MEDIA:TYPE=AUDIO,GROUP-ID=“B”,NAME=“ENGLISH”,DEFAULT=YES, \
  URI=“https://b.example.com/content/videos/video12/eng.m3u8”, \
  LANGUAGE=“en”,STABLE-RENDITION-ID=“Audio-37262”
#EXT-X-STREAM-INF:BANDWIDTH=1280000,AUDIO=“A”,PATHWAY-ID=“CDN-A”
low/video.m3u8
#EXT-X-STREAM-INF:BANDWIDTH=7680000,AUDIO=“A”,PATHWAY-ID=“CDN-A”, \
  STABLE-VARIANT-ID=“Video-768”
hi/video.m3u8
#EXT-X-STREAM-INF:BANDWIDTH=1280000,AUDIO=“B”,PATHWAY-ID=“CDN-B”
https://backup.example.com/content/videos/video12/low/video.m3u8
#EXT-X-STREAM-INF:BANDWIDTH=7680000,AUDIO=“B”,PATHWAY-ID=“CDN-B”, \
  STABLE-VARIANT-ID=“Video-768”
https://backup.example.com/content/videos/video12/hi/video.m3u8
```

Pathway Cloning Manifest response with PER-VARIANT-URIS and PER-RESOLUTION-URIS

```
{
  “VERSION”: 1,
  “TTL”: 60,
  “RELOAD-URI”:
“http://steeringserver.com?steering_params=eyJwcmV2UHRzIjpbImNkbl9hIiwiY2RuX2IiXSwicHRzIjpbeyJpZCI6ImNkbl9hI
iwidGhyb3VnaHB1dCI6IjIwOTcxNTIwMCJ9LHsiaWQiOiJjZG5fYiIsInRocm91Z2hwdXQiOiIyMDk3MTUyMDAifV0sIm1
pbkJSIjoiNTM2MjQ3OSJ9”,
  “PATHWAY-PRIORITY”: [
  “cdn1”,
  “cdn2”,
  “cdn3”
  ],
  “PATHWAY-CLONES”: [
  {
    “BASE-ID”: “cdn1”, // REQUIRED. Pathway ID of the Base Pathway from which cloning is done
    “ID”: “cdn3”, // REQUIRED. Pathway ID for the Pathway Clone
    “URI-REPLACEMENT”: // REQUIRED. URI replacement rules
    {
    “HOST”: “http://cdn3.com/<Base_URL>”, // OPTIONAL. Hostname for cloned URIs
    “PARAMS”: // OPTIONAL. Query parameters for cloned URIs
    {
      “steering_params”: <New Params>
    },
    “PER-VARIANT-URIS”: “http://faster.example.com/video/video.m3u8”,
    “PER-RESOLUTION-URIS”: “http://faster.example.com/audio/eng.m3u8”
    }
  }
  ]
}
```

In the above example Master manifest variants has “STABLE-VARIANT-ID” and “STABLE-RENDITION-ID” tags. This conveys player to stream these high-resolution variants from a dedicated server. With “PER-VARIANT-URIS” and “PER-RESOLUTION-URIS” content steering server can replace the URI of the variants whenever CDN3 (Cloned) is selected.

Time to Live (TTL) parameter used in computer networking to specify the lifespan or validity period of data packets or cached information. The TTL value indicates the maximum amount of time that a packet can remain in the network before it is discarded or considered invalid. TTL refers to the duration for which a particular content routing decision or cached information remains valid within the system's architecture.

The TTL value can be associated with routing decisions made by the edge servers when steering content delivery across multiple CDNs. By setting an appropriate TTL, the system ensures that routing decisions remain valid for a defined period, allowing for efficient content delivery without unnecessary re-routing.

In scenarios where certain content or CDN prioritization decisions are cached at the edge servers or the client devices, TTL can determine how long this cached information remains valid. This helps in avoiding stale or outdated data affecting subsequent content delivery decisions.

If the client device receives a steering response from the edge server containing a priority order of CDNs for content delivery, along with a TTL value of 300 seconds (5 minutes). This means that the client device should follow the specified CDN priority order for the next 5 minutes before re-evaluating the routing decision based on updated information. Similarly, if the edge server caches QoS information for CDNs with a TTL of 600 seconds (10 minutes), it ensures that the cached QoS data remains relevant for network performance analysis during subsequent content delivery sessions within the specified timeframe.

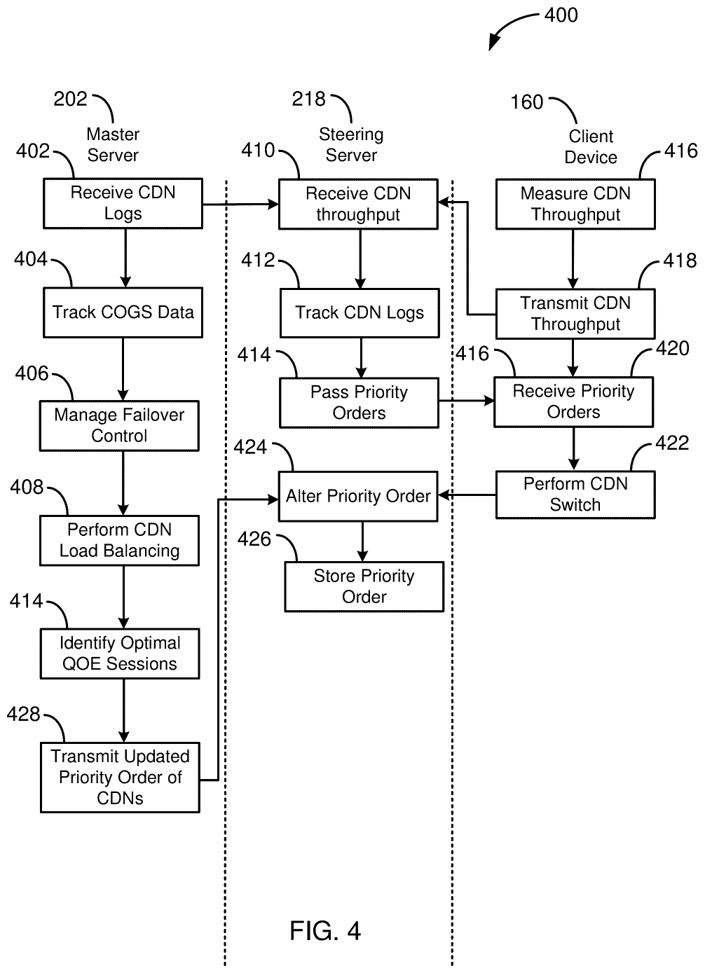

Referring to FIG. 4, illustrates a swim lane diagram 400 of a content steering process executed by various elements of the media content steering system 300 according to an embodiment of the present disclosure. The diagram 400 illustrates the interaction between various components including the master server 202, the edge steering server 218, and the client device 160, as well as the sequence of steps involved in steering chunked media content using the multiple CDNs.

At block 402, the master server 202 receive accurate statistics for all CDNs from the analytics engine 210, including the QOE/QOS and media usage statistics, or instance, consider a scenario where a popular streaming service utilizes multiple CDNs to distribute its content. The master server collects real-time data on the performance of each CDN, including metrics like latency, throughput, and error rates. Additionally, it gathers insights into media usage patterns, such as which content is being accessed frequently and at what times. This information allows the master server to make informed decisions regarding CDN selection, load balancing, and optimization strategies to enhance the overall content delivery experience for the end-users.

Through continuous monitoring and analysis of CDN statistics, the master server can identify trends, anomalies, and areas for improvement in the content delivery process. For example, it may detect fluctuations in network performance during peak hours or pinpoint areas where certain CDNs are underutilized or experience degraded performance.

At block 404, the master server 202 tracks CDN bandwidth usage, traffic on origins, and other other Cost of Goods Sold (COGS) and business-logic related information. For example, when a streaming platform utilizes multiple CDNs to deliver its content to the end-users worldwide. The master server 202 monitors the bandwidth utilization of each CDN, keeping tabs on data transfer rates, peak traffic periods, and overall network capacity usage. For instance, during a high-profile live streaming event, the master server 202 may observe a surge in bandwidth consumption across certain CDNs due to increased viewer engagement, requiring immediate adjustments to ensure smooth content delivery.

In addition to bandwidth usage, the master server 202 also tracks traffic on origins, which refers to the volume of requests directed towards the origin servers. For example, if a particular video segment goes viral on social media, the master server monitors the influx of requests for that specific content and assesses the impact on origin server traffic. By analyzing origin server traffic patterns, the master server 202 can optimize content caching strategies, allocate resources efficiently, and mitigate potential bottlenecks in the delivery pipeline.

At block 406, the master server 202 manages failover control, either manually or automatically based on continuous monitoring of the QOS statistics. For example, when a major CDN provider experiences a sudden network outage or degradation in the performance, impacting the delivery of streaming content to the end-users. In such cases, the master server promptly initiates failover procedures to mitigate service disruptions and ensure uninterrupted content delivery.

In a manual failover scenario, an operator or administrator overseeing the content delivery infrastructure detects the issues with the affected CDN and decides to transition traffic to alternative CDN providers. For instance, upon receiving alerts indicating a significant drop in QOS metrics or reports of widespread user complaints regarding playback issues, the operator intervenes to trigger manual failover. The master server 202 receives instructions from the operator to enact changes in CDN priorities, directing traffic away from the problematic CDN towards more reliable alternatives.

The master server 202 also employs automatic failover mechanisms, leveraging continuous monitoring of QOS statistics and real-time observations of CDN performance. For example, if the master server detects a persistent decline in QOS metrics, such as increased buffering, frequent interruptions, or deteriorating video quality across multiple sessions, it autonomously triggers failover procedures. By analyzing trends in QOS statistics and comparing them against predefined thresholds or benchmarks, the master server can swiftly identify instances of CDN failure or degradation and initiate failover actions without human intervention.

At block 408, the master server 202 is responsible for CDN load balancing and COGS optimizations, reflected in CDN priority orders. In an example, the master server 202 receives real-time updates on the CDN performance metrics and operational costs across multiple CDN providers. Based on these inputs, the master server dynamically adjusts CDN priority orders for each streaming session to distribute traffic evenly among the available CDN resources. For instance, if one CDN experiences increased traffic congestion or network latency, the master server may prioritize traffic allocation to alternative CDNs with lower utilization rates and better performance indicators. By strategically balancing traffic load across multiple CDNs, the master server optimizes resource utilization and enhances the overall scalability and resilience of the content delivery infrastructure.

Furthermore, the master server 202 also incorporates COGS optimizations into its decision-making process to achieve cost efficiencies in content delivery operations. For example, the master server analyzes operational costs, including CDN usage fees, data transfer costs, and other associated expenses, in conjunction with performance metrics and service level agreements (SLAs) with CDN providers. Based on this analysis, the master server may adjust CDN priority orders to prioritize CDN providers offering more favorable pricing structures or discounts for bulk data transfer. By aligning CDN selection with cost optimization objectives, the master server helps minimize operational expenses and maximize profit margins for content delivery service providers. This also leads identification of best session-level CDN priorities for ensuring optimal QOE at block 410.

At block 412, the edge steering server 218 receives initial CDN throughput statistics from the master server 202 at the beginning of the session. In an example scenario where a user initiates a streaming session to watch a high-definition video on a client device. As the session begins, the edge steering server receives initial CDN throughput statistics from the master server, providing insights into current performance levels and bandwidth capacities of each available CDN. These statistics may include metrics such as latency, packet loss, and data transfer rates, which help the edge steering server assess the suitability of each CDN for delivering the requested content.

Based on the initial throughput statistics received from the master server, the edge steering server can intelligently determine the most appropriate CDN to handle content delivery for the ongoing session. For instance, if one CDN exhibits superior performance metrics with low latency and high data transfer rates, the edge steering server may prioritize content delivery through that CDN to ensure optimal streaming experience for the user. Conversely, if another CDN experiences network congestion or performance degradation, the edge steering server may dynamically adjust its CDN selection to route traffic through alternative CDNs with better performance indicators.

At block 414, the edge steering server 218 tracks statistics of an active CDN based on player feedback. For example, when a user is streaming a popular live sports event on their client device using a media player application. As the streaming session progresses, the edge steering server continuously collects feedback from the media player regarding the quality of service experienced by the user, including metrics such as buffering time, video resolution, and playback stability.

Based on the player feedback received in real-time, the edge steering server analyzes the performance of the active CDN and compares it against predefined thresholds and quality benchmarks. If the player reports instances of buffering or degraded video quality, indicating suboptimal performance from a current CDN, the edge steering server may proactively initiate a CDN switch to redirect traffic through an alternative CDN with better performance characteristics.

At block 416, the edge steering server 218 passes CDN order instructions from the master server 202 to the client device 160. In an example scenario, where a user initiates a streaming session on their client device 160 to watch a popular movie through a media streaming application. Upon receiving the content request, the edge steering server consults the master server to obtain the current CDN priority order, which reflects the optimal selection of CDNs based on factors such as network latency, throughput, and server availability.

Once the edge steering server retrieves the CDN order instructions from the master server, it promptly forwards this information to the client device, instructing it to establish connections with the CDNs in the specified priority sequence. In this example, if the top-ranked CDN experiences network congestion or performance degradation during the streaming session, the client device seamlessly transitions to the next CDN in the prioritized list to ensure uninterrupted content delivery.

At block 418, the client device 160 measures throughput of a current CDN and reports the measured throughput to the edge steering server 218. For example, when a user is streaming a high-definition video on their client device using a media streaming application. As the streaming session progresses, the client device continually evaluates the throughput of the CDN responsible for delivering the content. If the measured throughput exceeds a predefined threshold, indicating robust network connectivity and efficient data transfer, the client device maintains its connection with the current CDN and continues receiving chunks of media content without interruption.

At block 420, the client device 160 respects CDN priority order received from the steering server, performing CDN switch decisions accordingly. For example when a user initiates a streaming session on their client device to watch a popular live sports event. Upon receiving the CDN priority order from the edge steering server, the client device evaluates the list of available CDNs and their respective priorities. Based on this information, the client device establishes an initial connection with the top-ranked CDN as indicated by the steering server.

As the streaming session progresses, the client device continuously monitors the performance metrics of the active CDN, including throughput, latency, and packet loss. If the client device detects any degradation in performance that could impact the streaming quality, such as decreased throughput or increased latency, it refers to the CDN priority order received from the steering server.

In response to the deteriorating performance of the current CDN, the client device autonomously initiates a CDN switch decision, seamlessly transitioning its connection to the next highest priority CDN in the list. By following the prescribed CDN priority order, the client device ensures that content delivery remains robust and uninterrupted, mitigating the effects of network fluctuations or CDN-related issues.

At block 422, the client device 160 makes CDN switch decisions in reaction to major network errors without waiting for instructions from the server. For example, a user is streaming a high-definition video on their client device while connected to a CDN. Suddenly, the network experiences a significant disruption, resulting in the generation of HTTP 4xx or 5xx error codes, indicating server or network issues. Upon detecting such errors, the client device immediately recognizes the severity of the network disruption and takes proactive measures to mitigate its impact on the streaming session.

In response to the network errors, the client device autonomously initiates CDN switch decisions, bypassing the need for instructions from the server. Leveraging its predefined error handling mechanisms, the client device swiftly redirects its connection to an alternate CDN with better network connectivity and reliability. By proactively switching CDNs in response to major network errors, the client device ensures uninterrupted content delivery and minimizes disruptions in the streaming experience for the user.

At block 424, the edge steering server 218 dynamically alters CDN priorities during the session based on QOS statistics or client feedback. For instance, consider a scenario where a user is streaming a live sports event on their client device, and the edge steering server initially assigns a CDN with high throughput as the primary content delivery source. However, midway through the streaming session, the QOS statistics indicate a gradual decline in network performance for the current CDN, leading to potential buffering or playback issues for the user.

Upon detecting the degradation in QOS, the edge steering server swiftly responds by dynamically altering CDN priorities, reassigning higher priority to an alternate CDN with better network performance.

At block 426, the edge steering server 218 preserves requested priorities to enable proper load distribution and expected effects on COGS and QOE. For example, when a streaming service experiences a surge in user traffic during peak hours, resulting in increased demand on CDN resources. In this scenario, the edge steering server prioritizes CDNs based on predetermined load balancing algorithms, ensuring that content is distributed across multiple CDNs to prevent overloading any single network.

By preserving the requested priorities, the edge steering server effectively manages the distribution of content chunks, maintaining a balanced load across CDNs to optimize network performance and prevent congestion. This approach not only enhances QOE by minimizing buffering and latency but also optimizes COGS by efficiently utilizing available CDN resources.

Additionally, the edge steering server continuously evaluates network conditions and user feedback to dynamically adjust CDN priorities as needed. For instance, if a particular CDN experiences a sudden decrease in performance or becomes unavailable due to network issues, the edge steering server promptly redistributes traffic to alternative CDNs with better performance metrics.

At block 428, the master server 202 transmits state updates and priority order updates to edge servers based on failover decisions or optimizations. In an example, one of the CDNs experiences a sudden outage or degradation in performance due to network issues. In response to this event, the master server detects the anomaly through continuous monitoring QOS statistics or the client feedback. Upon identifying the problem, the master server initiates failover procedures by transmitting state updates to the edge servers.

Upon receiving the state updates from the master server, the edge servers promptly adjust their CDN priorities and routing configurations to divert traffic away from the affected CDN. This proactive approach helps mitigate the impact of the outage on content delivery, ensuring that users continue to receive uninterrupted streaming experiences.

Furthermore, the master server 202 may also transmit priority order updates to the edge servers 212 based on optimization strategies aimed at improving performance or reducing costs. For example, if the master server determines that reallocating traffic to specific CDNs can optimize load distribution or reduce operational expenses, it will transmit corresponding priority order updates to the edge servers 212.

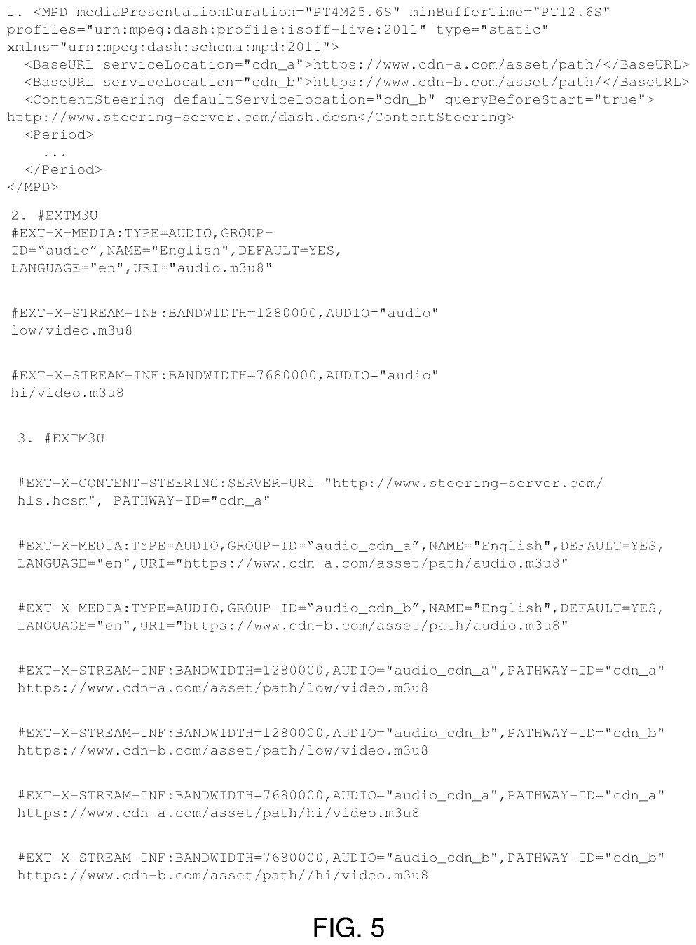

Referring to FIG. 5, illustrates a media presentation description (MPD) file according to an embodiment of the present disclosure. A first segment of FIG. 5 shows how a DASH manifest should look to allow a video player to start fetching information from a content steering server 218. The manifest updater 204 is responsible for updating the incoming DASH and HLS original manifest.

In case of DASH, the manifest updater 204 adds the following elements in the MPD files:
a BaseURL tag for each CDN to be included in a switching mix.
a single ContentSteering tag that provides the steering server URL that the player should use for the first interaction with the steering server.

A second segment of FIG. 5 shows HLS manifest, the manifest updater 204 adds the following elements in the master playlist:
a custom tag EXT-X-CONTENT-STEERING with the steering server information
a PATHWAY-ID as part of #EXT-X-STREAM-INF for each of the involved CDNs in a session.

A third segment of the FIG. 5 is an updated manifest file by the manifest updater 204.

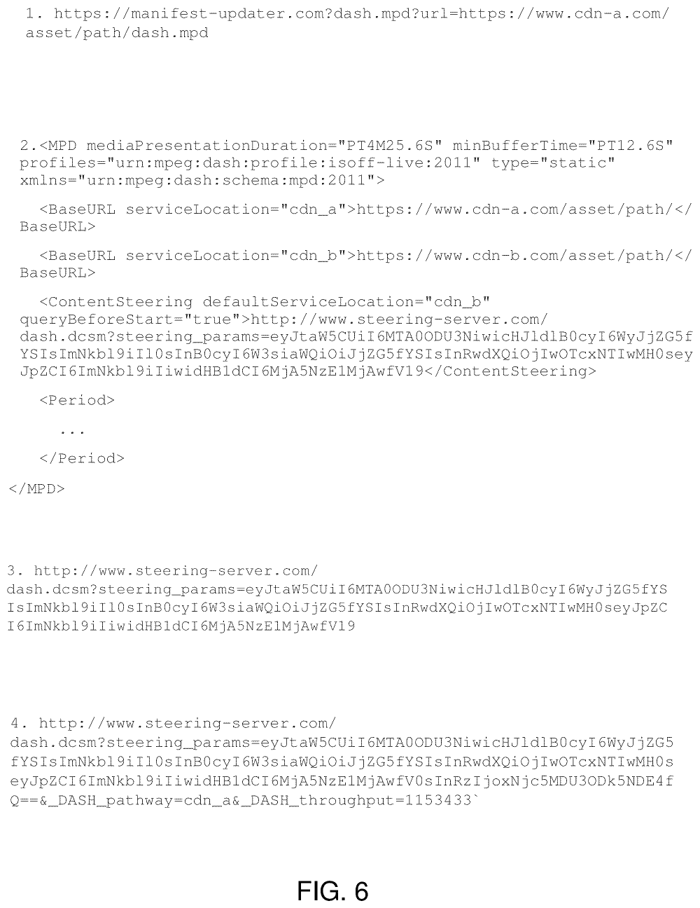

Referring to FIG. 6, illustrates a media presentation description (MPD) file according to an embodiment of the present disclosure. In the first segment of FIG. 6, The video player fetches the DASH manifest from the manifest updater 204. The manifest origin returns a plain DASH manifest to the manifest updater 204.

The manifest updater 204 processes an original DASH manifest, adding the BaseURL and ContentSteering tags mentioned earlier and returns the manifest file as shown in segment two.

The key in the above example is the steering_params parameter included in the URL inside the ContentSteering tag. The URL is string that is the base64 representation of this JSON (minified):

```
{
  “minBR”: 1048576,
  “prevPts”: [
  “cdn_a”,
  “cdn_b”
  ],
  “pts”: [
  {
    “id”: “cdn_a”,
    “tput”: 209715200
  },
  {
    “id”: “cdn_b”,
    “tput”: 209715200
  }
  ]
}
```

Where:
pts is a list of objects containing pathway identifiers (id) and their estimated throughput (tput). We expect these values to be filled from historical data, but we arbitrarily set them to 200 Mbps in the example.
prevPts (previous pathways) is the ordered list of preferred CDNs to be used to start a media session.
minBR (minimum bitrate) is the minimum bitrate represented in the manifest in bytes per second. It should usually be the sum of the lowest rendition bitrates for audio and video AdaptationSet. In the example, it stands for 1 MBps.
defaultServiceLocation is the CDN identifier to be used if there is no information available from the Steering server.
queryBeforeStart indicates to the video player whether the content steering server should be contacted before starting to fetch media segments from the defaultServiceLocation. In the example it is set to true, so we expect the Player to try to interact with the content steering server to determine which CDN to use.

Segment three shows the URL, by which the video player will then contact the steering server. The steering server will process the request by decoding the steering_params query string parameter in the URL. With that information, the server will then determine which is the preferred CDN order to be used by the player. In this case, as no more information is provided, the server will return the same order as in the prevPts list. A new steering URL should be built, including the new steering_params we want to carry over the next steering request. The only change, in this case, is a timestamp (ts, in epoch UTC) we include to track the request time. The steering_params would then be:

```
{
  “minBR”: 1048576,
  “prevPts”: [
  “cdn_a”,
  “cdn_b”
  ],
  “pts”: [
  {
    “id”: “cdn_a”,
    “tput”: 209715200
  },
  {
    “id”: “cdn_b”,
    “tput”: 209715200
  }
  ],
  “ts”: 1679057899418
}
```

The video player should then start fetching the media segments from the first CDN in the SERVICE-LOCATION-PRIORITY field of the steering response. In the example, that means using the BaseURL with serviceLocation=cdn_a.

The Player will continue fetching media segments from cdn_a for the number of seconds in the TTL field in the steering response.

After the number of seconds in the TTL field in the previous steering response, the video player must request again the steering server 218 for a new priority list. In this request, the Player must include two extra query parameters in the URL:
__DASH_pathway, which must indicate the identifier of the last used CDN.
_DASH_throughput, which must indicate the measured throughput (in bits per second) when fetching media segments from the last used CDN.

For the sake of the example, let us assume the Player calls the following URL, including the steering_params parameter the Content Steering server returned in its last response.
http://www.steering-server.com/dash.desm?steering_params=eyJtaW5CUiI6MTA0ODU3NiwicHJldlBOcyI6WyJj ZG5fYSIsImNkbl9iIlOsInBOcyI6W3siaWQiOiJjZG5fYSIsInRwdXQiOjIwOTcxNTIwMHOs eyJpZCI6ImNkbl9iIiwidHB1dCI6MjA5NzE1MjAwfV0sInRzIjoxNjc5MDU3ODk5NDE4fQ==&_DASH_pathway=cdn_a&_DASH_throughput=1153433

With the above request, the Player informed the Content Steering server the measured throughput from cdn_a was 1.1 Mbps (1153433bps), below 1.2 Mbps, which would be the minBR value plus a 20% safety margin.

The Content Steering server will then notice the reported used CDN is not behaving as expected and that is having an impact on video QoE. A steering logic will then determine the next CDN in the priority list (cdn_b) that should be used.

Also, the throughput for cdn_a must be updated in the corresponding entry in the pts list. To update the value, we use this expression:

$$throughput\_ \{ n \} = ∖ alpha * \_DASH \_throughput + ( 1 - alpha ) * throughput\_ \{ n - 1 \}$$

All in all, using a=0.7, the new steering_params should be the following:

```
{
  “minBR”: 1048576,
  “prevPts”: [
  “cdn_b”,
  “cdn_a”
  ],
  “pts”: [
  {
    “id”: “cdn_a”,
    “tput”: 63721963
  },
  {
    “id”: “cdn_b”,
    “tput”: 209715200
  }
  ],
  “ts”: 1678972536
}
```

The steering server will then return the following response:

```
{
  “VERSION”: 1,
  “TTL”: 30,
  “RELOAD-URI”: “http: //www.steering-
server.com/dash.dcsm?steering_params=eyJtaW5CUiI6MTA0ODU3NiwicHJldlB0cyI6WyJjZG
5fYiIsImNkbl9hIl0sInB0cyI6W3siaWQiOiJjZG5fYSIsInRwdXQiOjYzNzIxOTYzfSx7ImlkIjoi
Y2RuX2IiLCJ0cHV0IjoyMDk3MTUyMDB9XSwidHMiOjE2Nzg5NzI1MzZ9”,
  “SERVICE-LOCATION-PRIORITY”: [
  “cdn_b”,
  “cdn_a”
  ]
}
```

The Player will keep fetching media segments from cdn_b.

After the TTL, the Player will request again the Content Steering server for a new priority list.

The steering_params will be the same as the earlier one but will contain updated values for throughput from cdn_b:

```
{
  “minBR”: 1048576,
  “prevPts”: [
  “cdn_b”,
  “cdn_a”
  ],
  “pts”: [
  {
    “id”: “cdn_a”,
    “tput”: 63721963
  },
  {
    “id”: “cdn_b”,
    “tput”: 77594624
  }
  ],
  “ts”: 678972581
}
```

Which will generate the following steering manifest:

```
{
  “VERSION”: 1,
  “TTL”: 30,
  “RELOAD-URI”: “http: //www.steering-
server.com/dash.dcsm?steering_params=eyJtaW5CUiI6MTA0ODU3NiwicHJldlB0cyI6WyJjZG
5fYiIsImNkbl9hIl0sInB0cyI6W3siaWQiOiJjZG5fYSIsInRwdXQiOjYzNzIxOTYzfSx7ImlkIjoi
Y2RuX2IiLCJ0cHV0Ijo3NzU5NDYyNH1dLCJ0cyI6Njc4OTcyNTgxfQ==”,
  “SERVICE-LOCATION-PRIORITY”: [
  “cdn_b”,
  “cdn_a”
  ]
}
```

The video player will keep requesting media segments to cdn_b until the Content Steering server responds with a different priority list in any subsequent steering request.

The example above showed a use case in which the Content Steering server drives the Player to switch to a better-performing CDN before the user can notice a drop in video quality due to the ABR algorithm of Player switches to lower renditions.

The steering operation with HLS assets is mostly identical, except for following changes:
replacing the/dash.dcsm endpoint by/hls.hcsm,
the_DASH_patway & _DASH_throughput parameters would be_HLS_patway & _HLS_throughput instead,
and the SERVICE-LOCATION-PRIORITY field in the steering manifest would become PATHWAY-PRIORITY.

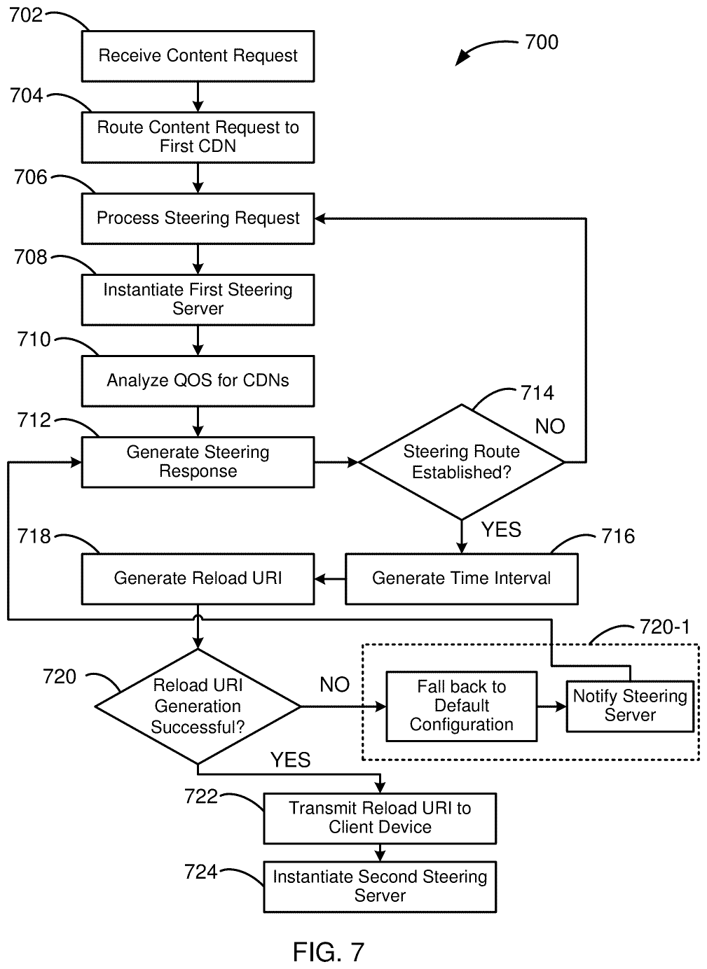

Referring to FIG. 7, illustrates a method 700 for steering media content according to an embodiment of the present disclosure. Some steps of method 700 may be performed by the systems 200, 300 by utilizing processing resources through any suitable hardware, non-transitory machine-readable medium, or a combination thereof.

At block 702, a content request is received, which is essential for initiating the content delivery process. This task is typically performed by the master server 202, which acts as the central coordinator of the content delivery system 120. Upon receiving the content request, the master server 202 identifies the requested media content and prepares to route it to the appropriate content delivery network (CDN) for efficient delivery to the client device.

At block 704, the content request is routed to the first CDN, a crucial step in the content delivery process. This task is typically handled by the second edge server 306 situated within the first CDN. The edge server 212 acts as a gateway between the client device and the CDN, ensuring that the content request is properly directed to the CDN's infrastructure for further processing.

At block 706, a steering request is processed, which involves analyzing various factors to optimize the content delivery process. This task is performed by the edge steering server 218, a component responsible for making dynamic decisions regarding CDN selection and content delivery routing. The steering request may include information about the client's network conditions, current CDN performance, and other relevant parameters.

At block 708, the first steering server 308 is instantiated, marking the beginning of the content steering process. The first steering server 308 operates in a stateless manner, meaning it does not retain information about past interactions or session states. This allows for scalability and flexibility in handling content delivery requests from multiple client devices simultaneously.

At block 710, the the quality of service (QOS) for the available CDNs is analyzed by gathering data on factors such as network latency, throughput, and reliability. This task is performed by the edge steering server 218, which continuously monitors the performance of each CDN to make informed decisions about content delivery routing.

At block 712, a steering response is generated based on the analyzed QOS information and other relevant parameters. This response includes a steering route that specifies the priority order of the available CDNs for delivering the content chunks. The steering response is crucial for ensuring efficient and reliable content delivery to the client device.

At block 714, the system checks whether the steering route has been successfully established. If the steering route is established, the system proceeds to generate a time interval for subsequent steering requests. However, if the steering route is not established, the system returns to block 706 to process another steering request and attempt to establish a valid route.

At block 716, a steering route has been successfully established is verified. If the steering route has been established, indicating that the priority order of CDNs for content delivery has been determined, the system proceeds to generate a time interval for subsequent steering requests. This time interval serves as a delay period before the system initiates further steering requests, allowing for optimal utilization of resources and preventing excessive steering requests that could potentially overwhelm the network or CDN infrastructure. The duration of the time interval may be dynamically determined based on factors such as network conditions, CDN performance, and content delivery requirements. By implementing a time interval between steering requests, the system can efficiently manage the distribution of content across CDNs while ensuring smooth and uninterrupted playback for end-users. At block 718, a reload uniform resource identifier (URI) is generated to serve as a mechanism for triggering the instantiation of a second steering server 310. This task is performed by the edge steering server 218, which dynamically adjusts the content delivery routing based on real-time network conditions and client device requirements.

At block 720, the system verifies whether the generation of the reload URI was successful. If the generation is successful, the system proceeds to transmit the reload URI to the client device. However, if the generation fails, the system may fall back to a default configuration and notify the steering server to reassess the content delivery routing strategy.

At block 722, the reload URI is transmitted to the client device, allowing it to trigger the instantiation of the second steering server 310. This task ensures seamless and dynamic adaptation of the content delivery routing based on changing network conditions and client device requirements.

At block 724, the second steering server 310 is instantiated, completing the content steering process. The second steering server 310 operates in conjunction with the first steering server 308 to dynamically optimize the content delivery routing and ensure efficient and reliable delivery of media content to the client device.

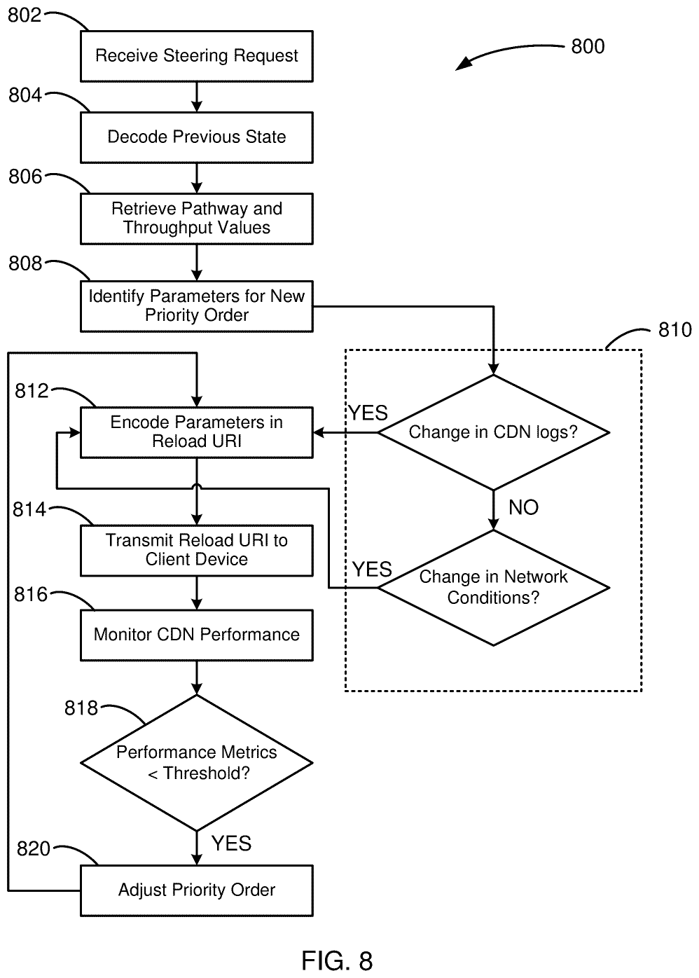

Referring to FIG. 8, illustrates a method 800 for steering media content according to an embodiment of the present disclosure. Some steps of method 800 may be performed by the systems 200, 300 by utilizing processing resources through any suitable hardware, non-transitory machine-readable medium, or a combination thereof.

At block 802, a steering request is received from the client device, initiating the process of dynamically optimizing the content delivery routing. This task is typically handled by the edge steering server 218, which acts as the decision-making component responsible for adjusting CDN priorities based on real-time network conditions and performance metrics.

At block 804, a previous state is decoded from the parameters included in the steering request. This previous state contains encoded information about the client's past interactions with the server and the current context of the request. By decoding the previous state, the system gains insights into the client's historical preferences and network conditions.

At block 806, a pathway and throughput values are retrieved from the decoded parameters, essential for determining the optimal content delivery pathway and ensuring efficient data transfer based on network conditions. This task is crucial for dynamically adjusting CDN priorities to maximize performance and reliability during content delivery.

At block 808, parameters are identified for a new priority order based on the decoded state and current network conditions. This task involves analyzing various factors such as CDN performance metrics, network latency, and client device requirements to determine the most optimal CDN priority order for delivering content chunks.

At block 810, the system checks for any changes in CDN logs or network conditions that may necessitate an adjustment in the priority order. If changes are detected, the system proceeds to block 812 to encode the parameters in a reload URI. Otherwise, the system continues monitoring CDN performance and network conditions at block 816.

At block 812, the parameters encoded for the new priority order in a reload URI, which serves as a mechanism for triggering the client device to adjust its content delivery routing accordingly. This task ensures seamless and dynamic adaptation of the content delivery routing based on changing network conditions and performance metrics.

At block 814, the reload URI is transmitted to the client device, allowing it to adjust its content delivery routing based on the updated priority order. This task enables the client device to dynamically optimize its CDN selection and ensure efficient and reliable delivery of media content.

At block 816, the system continuously monitors CDN performance and network conditions to ensure optimal content delivery routing. This task involves tracking various performance metrics, such as throughput, latency, and error rates, to detect any anomalies or degradation in CDN performance.

At block 818, the system checks whether the performance metrics are below a predefined threshold. If the metrics fall below the threshold, indicating a degradation in CDN performance, the system proceeds to block 820 to adjust the priority order and encode the parameters in a reload URI for transmission to the client device.

At block 820, if the performance metrics are below the threshold, the system adjusts the priority order based on the current network conditions and performance metrics. This task ensures that the content delivery routing remains optimized to maintain high-quality playback and user experience.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

We claim:

1. A system for steering chunked media content using a plurality of content delivery networks (CDNs) and an edge computing platform, the system comprising:
a first edge server of the edge computing platform at one of the plurality of CDNs to:
receive a content request identifying a media content for playback on a client device, wherein:
the media content is divided into a plurality of chunks; and
the content request is routed to a first CDN, and
deliver at least some of the plurality of chunks to the first CDN; and
a second edge server at the first CDN to:
process a steering request to instantiate a first steering server wherein:
the first steering server is initially stateless; and
first parameters from the client device program operation of the first steering server,
analyze quality of service (QOS) information for the plurality of CDNs,
determine a priority order of the plurality of CDNs for delivering the plurality of chunks going forward,
generate from the first steering server at least two of:
a steering response having a steering route that includes a priority order of the plurality of CDNs;
a time interval for subsequent steering requests; and
a reload uniform resource identifier (URI) to instantiate a second steering server, and,
pass the reload URI to the client device to trigger the second steering server to be instantiated with the plurality of CDNs after the time interval.

2. The system for steering chunked media content using the plurality of CDNs and the edge computing platform as claimed in claim 1, wherein the content request received at the first edge server comprises a manifest file that includes metadata associated with the media content.

3. The system for steering chunked media content using the plurality of CDNs and the edge computing platform as claimed in claim 1, wherein the first parameters from the client device includes bandwidth, latency, and throughput information.

4. The system for steering chunked media content using the plurality of CDNs and the edge computing platform as claimed in claim 1, wherein the second edge server analyzes the QOS information by:
monitoring performance metrics of each of the plurality of CDNs in real-time, and
analyzing data associated with historical performance of each of the plurality of CDNs in real-time.

5. The system for steering chunked media content using the plurality of CDNs and the edge computing platform as claimed in claim 1, wherein the second edge server determines the priority order for each of the plurality of CDNs comprises considering:
data associated with historical performance of each of the plurality of CDNs,
geographical proximity of the plurality of CDNs to the client device, and
network conditions at the client device.

6. The system for steering chunked media content using the plurality of CDNs and the edge computing platform as claimed in claim 1, wherein the first steering server is configured to dynamically adjust the steering route based on:
real-time changes in network conditions,
performance metrics of the plurality of CDNs, and
indicators associated with quality of experience (QOE) and quality of service (QOS).

7. The system for steering chunked media content using the plurality of CDNs and the edge computing platform as claimed in claim 1, wherein the system further comprises a manifest updater to:
update a manifest file received in the content request with URI's of at least some of the plurality of chunks, and
upon updating, transmit the manifest file to the client device in accordance with Dynamic Adaptive Streaming over HTTP (DASH) or HTTP Live Streaming (HLS) protocols.

8. The system for steering chunked media content using the plurality of CDNs and the edge computing platform as claimed in claim 1, wherein the first edge server is configured to:
periodically monitors performance metrics of the plurality of CDNs to analyze load distribution across the plurality of CDNs, and
adjust the priority order of the plurality of CDNs for delivering the plurality of chunks based on the load distribution.

9. The system for steering chunked media content using the plurality of CDNs and the edge computing platform as claimed in claim 1, wherein the first steering sever is further configured to monitor a throughput of a live CDN from the plurality of CDNs.

10. The system for steering chunked media content using the plurality of CDNs and the edge computing platform as claimed in claim 1, wherein the first and second edge servers use a same server at the first CDN.

11. The system for steering chunked media content using the plurality of CDNs and the edge computing platform as claimed in claim 1, wherein the first edge server of the edge computing platform is further configured to:
receive a content steering request from a media player, the content steering request including:
an indication of a current CDN used by the media player to receive chunked media content,
an indication of throughput of the current CDN, as measured by the client device for receiving the chunked media content, and
a parameter string carrying information about the state of the steering server, including a priority order of the CDNs used for delivering quality of service (QOS) information for the plurality of CDNs in the priority order list;
generate a new state of the steering server, including:
an updated priority order for list of the CDNs, and
updated QOS information for the plurality of CDNs in the priority order list; and
generate a steering response to the media player, including:
an updated priority order of the plurality of the CDNs,
a time interval for subsequent steering requests; and
a reload uniform resource identifier (URI) to instantiate a second edge server of edge computing platform, wherein, the reload URI includes parameter string carrying information about the new state of the steering server generated while processing the current request.

12. A method for steering chunked media content using a plurality of content delivery networks (CDNs) and the edge computing platform, the method comprising:
receiving a content request identifying a media content for playback on a client device, wherein:
the media content is divided into a plurality of chunks; and
the content request is routed to a first CDN, and
delivering at least some of the plurality of chunks to the first CDN;
processing a steering request to instantiate a first steering server wherein:
the first steering server is initially stateless; and
first parameters from the client device program operation of the first steering server,
analyzing quality of service (QOS) information for the plurality of CDNs,
determining a priority order of the plurality of CDNs for delivering the plurality of chunks going forward,
generating from the first steering server at least two of:
a steering response having a steering route that includes a priority order of the plurality of CDNs;
a time interval for subsequent steering requests; and
a reload uniform resource identifier (URI) to instantiate a second steering server, and;
passing the reload URI to the client device to trigger the second steering server to be instantiated with the plurality of CDNs after the time interval.

13. The method for steering chunked media content using the plurality of CDNs and the edge computing platform as claimed in claim 12, wherein the content request comprises a manifest file that includes metadata associated with the media content.

14. The method for steering chunked media content using the plurality of CDNs and the edge computing platform as claimed in claim 12, wherein the first parameters from the client device includes bandwidth, latency, and throughput information.

15. The method for steering chunked media content using the plurality of CDNs and the edge computing platform as claimed in claim 12, wherein the QOS information is analyzed by:
monitoring performance metrics of each of the plurality of CDNs in real-time, and
analyzing data associated with historical performance of each of the plurality of CDNs in real-time.

16. The method for steering chunked media content using the plurality of CDNs and the edge computing platform as claimed in claim 12, wherein determining the priority order for each of the plurality of CDNs comprises considering:
data associated with historical performance of each of the plurality of CDNs,
geographical proximity of the plurality of CDNs to the client device, and
network conditions at the client device.

17. The method for steering chunked media content using the plurality of CDNs and the edge computing platform as claimed in claim 12, wherein the method further comprises dynamically adjusting the steering route based on:
real-time changes in network conditions,
performance metrics of the plurality of CDNs, and
indicators associated with quality of experience (QOE) and quality of service (QOS).

18. The method for steering chunked media content using the plurality of CDNs and the edge computing platform as claimed in claim 12, wherein the method further comprises:
updating a manifest file received in the content request with URI's of at least some of the plurality of chunks, and
upon updating, transmit the manifest file to the client device in accordance with Dynamic Adaptive Streaming over HTTP (DASH) or HTTP Live Streaming (HLS) protocols.

19. The method for steering chunked media content using the plurality of CDNs and the edge computing platform as claimed in claim 12, wherein the method further comprises:
periodically monitoring performance metrics of the plurality of CDNs to analyze load distribution across the plurality of CDNs, and
adjusting the priority order of the plurality of CDNs for delivering the plurality of based on the load distribution.

20. The method for steering chunked media content using the plurality of CDNs and the edge computing platform as claimed in claim 12, wherein the method further comprises monitoring a throughput of a live CDN from the plurality of CDNs.

21. The method for steering chunked media content using the plurality of CDNs and the edge computing platform as claimed in claim 12, wherein the method further comprises:
receiving a content steering request from a media player, the content steering request including:
an indication of a current CDN used by the media player to receive chunked media content,
an indication of throughput of the current CDN, as measured by the client device for receiving the chunked media content, and
a parameter string carrying information about the state of the steering server, including a priority order of the CDNs used for delivering quality of service (QOS) information for the plurality of CDNs in the priority order list;
generating a new state of the steering server, including:
an updated priority order for list of the CDNs, and
updated QOS information for the plurality of CDNs in the priority order list; and
generating a steering response to the media player, including:
an updated priority order of the plurality of the CDNs,
a time interval for subsequent steering requests; and
a reload uniform resource identifier (URI) to instantiate a second edge
server of edge computing platform, wherein, the reload URI includes parameter string carrying information about the new state of the steering server generated while processing the current request.

22. A non-transitory computer-readable medium having instructions embedded thereon for steering chunked media content using a plurality of content delivery networks (CDNs) and an edge computing platform, wherein the instructions, when executed by one or more computers, cause the one or more computers to:
receive a content request identifying a media content for playback on a client device, wherein:
the media content is divided into a plurality of chunks; and
the content request is routed to a first CDN, and
deliver at least some of the plurality of chunks to the first CDN;
process a steering request to instantiate a first steering server wherein:
the first steering server is initially stateless; and
first parameters from the client device program operation of the first steering server,
analyze quality of service (QOS) information for the plurality of CDNs,
determine a priority order of the plurality of CDNs for delivering the plurality of chunks going forward,
generate from the first steering server at least two of:
a steering response having a steering route that includes a priority order of the plurality of CDNs;
a time interval for subsequent steering requests; and
a reload uniform resource identifier (URI) to instantiate a second steering server, and;
pass the reload URI to the client device to trigger the second steering server to be instantiated with the plurality of CDNs after the time interval.
